(19) United States
(12) Patent Application Publication
(10) Pub. No.: US 2020/0256982 A1
(43) Pub. Date: Aug. 13, 2020

(54) SYNTHETIC APERTURE DIRECTION FINDING AND GEOLOCATION

(71) Applicant: BAE SYSTEMS INFORMATION AND ELECTRONIC SYSTEMS INTEGRATION INC., Nashua, NH (US)

(72) Inventors: Matthew P. Slaven, Candia, NH (US); Richard E. Clymer, Concord, NH (US); Gregory S. Laste, Hudson, NH (US)

(73) Assignee: BAE SYSTEMS INFORMATION AND ELECTRONIC SYSTEMS INTEGRATION INC., Nashua, NH (US)

(21) Appl. No.: 16/274,419

(22) Filed: Feb. 13, 2019

(51) Int. Cl. G01S 13/93; G01S 13/90

(52) U.S. Cl. CPC G01S 13/9303; G01S 13/9023; G01S 13/9017; G01S 13/9029

(57) ABSTRACT

A direction finding system and method to utilize synthetic apertures within a single short pulse transmission to extrapolate additional data relating to the signal to thereby increase the accuracy of the direction finding results given by a single short pulse is provided. The direction finding system may further exploit the movement of a platform to create the synthetic apertures within the signal data.

### TECHNICAL FIELD

The present disclosure relates generally to the field of direction finding as it relates to identifying the source direction of an emitted signal. More particularly in one example, the present disclosure relates to a process of direction finding utilizing synthetic aperture measurements. Specifically, in another example, the present disclosure relates to a process of direction finding that takes advantage of the motion of the sensing platform to take multiple samples from a single detected radar pulse and utilizing synthetic apertures to create a more accurate direction finding result.

### BACKGROUND

### Background Information

The process of locating the source of an emitted signal, which is known as direction finding (DF), is common to many applications. For example, direction finding can be used in navigation, search and rescue, tracking wildlife, and locating illegal transmitters. In military applications, direction finding helps in target acquisition and tracking of enemy locations and movements. Nearly all modern militaries use some form of direction finding to guide their ships, aircraft, troops, and/or munitions in one or more ways. For example, direction finding is the process by which enemy emitters are detected and/or geolocated, thus providing information to military operators as to location and type of emitter being used which can further be used to identify enemy units and/or troops and the movements thereof.

As military technology advances, new emitters have come online that are capable of operation in multiple frequencies of the electromagnetic spectrum and across multiple channels. These advanced emitters are capable of both broadcasting and receiving in short, non-continuous bursts and are considered to be very agile systems that may jump through frequency and dynamic ranges to evade detection while maintaining effective detection capabilities on their own. Most of these modern emitters have a low probability of intercept (LPI) and emit single short radar pulses at varying intervals in their attempts to avoid detection.

Typically, current direction finding systems may detect a single pulse from one of these LPI emitters and may attempt to use that single pulse to determine the direction of origin of the detected signal. Often these current systems fall short of this objective, and therefore require multiple pulses detected over a period of time to provide an accurate direction finding result. Thus, when faced with a single short-lived pulse from an emitter, most current direction finding systems have a large probability of error and have difficulty narrowing down the true angle to the emitter.

### SUMMARY

The present disclosure addresses these and other issues by providing a direction finding system and method to utilize synthetic apertures within a single short pulse transmission to extrapolate additional data relating to the signal thereby increasing the accuracy of the direction finding results given by a single short pulse.

In one aspect, an exemplary embodiment of the present disclosure may provide a system comprising: a moving platform; at least one antenna array including a plurality of antennas therein; a receiver; at least one processor capable of executing logical functions in communication with the receiver and the at least one antenna array; and at least one non-transitory computer readable storage medium having instructions encoded thereon that, when executed by the at least one processor, implements operations to determine the direction of origin for an incoming signal, the instructions including: detect an incoming signal; measure the length of the incoming signal; assign a plurality of sampling apertures for signal data from the incoming signal according to one or more of a velocity, heading, and position of the moving platform; sample the signal data at more than one of the plurality of assigned sampling apertures; package the signal data in multiple data sets according to the number of samples taken from the plurality of assigned sampling apertures into a pulse descriptor word (PDW); apply at least one direction finding process to the PDW; and generate a geolocation and direction finding result from the PDW. This exemplary embodiment or another exemplary embodiment may further provide wherein the instructions further include: communicate at least one of the geolocation and direction finding results to one or both of the moving platform and an operator thereof. This exemplary embodiment or another exemplary embodiment may further provide wherein the plurality of sampling apertures are predetermined prior to detection of the incoming signal. This exemplary embodiment or another exemplary embodiment may further provide wherein the plurality of sampling apertures are calculated by the receiver after the incoming signal terminates and further according to the measured length of time of the incoming signal. This exemplary embodiment or another exemplary embodiment may further provide wherein the moving platform is an aircraft. This exemplary embodiment or another exemplary embodiment may further provide wherein the at least one antenna array is a single linear array. This exemplary embodiment or another exemplary embodiment may further provide wherein the at least one antenna array is a dual orthogonal linear array. This exemplary embodiment or another exemplary embodiment may further provide wherein the signal data is sampled at each of the plurality of assigned sampling apertures.

In another aspect, an exemplary embodiment of the present disclosure may provide a method of direction finding comprising: detecting an incoming signal via an antenna array including a plurality of antennas carried by a moving platform; measuring a transmission length of the incoming signal; assigning a plurality of sampling apertures for data from the incoming signal according to one or more of a velocity, heading, and position of the moving platform; sampling the signal data at more than one of the plurality of assigned sampling apertures; packaging the signal data in multiple data sets equal to the number of samples taken from the plurality of assigned sampling apertures into a pulse descriptor word (PDW); applying at least one direction finding process to the PDW; and generating a geolocation and direction finding result from the PDW. This exemplary embodiment or another exemplary embodiment may further provide communicating at least one of the geolocation and direction finding results to one or both of the moving platform and an operator thereof. This exemplary embodiment or another exemplary embodiment may further provide predetermining the plurality of sampling apertures prior to detection of the incoming signal. This exemplary embodiment or another exemplary embodiment may further provide calculating the plurality of sampling apertures by a receiver after the incoming signal terminates and further according to the measured length of the incoming signal. This exemplary embodiment or another exemplary embodiment may further provide wherein the moving platform is an aircraft and the method further comprises: moving the aircraft from a first position to a second position while detecting the incoming signal. This exemplary embodiment or another exemplary embodiment may further provide wherein the at least one antenna array is a single linear array and detecting the incoming signal is performed by the single linear array. This exemplary embodiment or another exemplary embodiment may further provide wherein the at least one antenna array is a dual orthogonal linear array and detecting the incoming signal is performed by the dual orthogonal linear array. This exemplary embodiment or another exemplary embodiment may further provide sampling the signal data at each of the plurality of assigned sampling apertures.

In yet another aspect, an exemplary embodiment of the present disclosure may provide a method comprising: calculating a plurality of sampling apertures to apply to a signal detected by at least one antenna array with a plurality of antennas carried by a moving platform; sampling the detected signal at two or more of the plurality of sampling apertures to collect data regarding the signal characteristics; comparing the collected signal data from each of the two or more sampled apertures and applying at least one direction finding process to the collected signal data; and communicating the direction finding result to one or both of the moving platform and an operator thereof. This exemplary embodiment or another exemplary embodiment may further provide calculating the plurality of sampling apertures after the detection of the incoming signal and according to the measured transmission length of time of the detected signal and one or more of a velocity, heading, and position of the moving platform. This exemplary embodiment or another exemplary embodiment may further provide wherein the at least one antenna array is a single linear array and detecting the incoming signal is performed by the single linear array. This exemplary embodiment or another exemplary embodiment may further provide wherein the at least one antenna array is a dual orthogonal linear array and detecting the incoming signal is performed by the dual orthogonal linear array.

In yet another aspect, an exemplary embodiment of the present disclosure may provide a method comprising: detecting an incoming signal via at least one antenna array including a plurality of antennas carried by an aircraft; measuring the length of time of the incoming signal; assigning a plurality of sampling apertures for data from the incoming signal according to one or more of a velocity, heading, and position of the aircraft; sampling the signal data at more than one of the plurality of assigned sampling apertures; packaging the signal data in multiple data sets equal to the number of samples taken from the plurality of assigned sampling apertures into a pulse descriptor word (PDW); applying at least one direction finding process to the PDW; generating a geolocation and direction finding result from the PDW; communicating at least one of the geolocation and direction finding results to one or both of the moving platform and an operator thereof. This exemplary embodiment or another exemplary embodiment may further provide wherein the plurality of sampling apertures are predetermined prior to detection of the incoming signal. This exemplary embodiment or another exemplary embodiment may further provide wherein the plurality of sampling apertures are calculated by a receiver after the incoming signal terminates and further according to the measured length of time of the incoming signal. This exemplary embodiment or another exemplary embodiment may further provide wherein the at least one antenna array is a dual orthogonal linear array.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1A is a schematic view of a single linear array system according to one aspect of the present disclosure.

FIG. 1B is an overhead schematic view of a single linear array system installed on a platform according to one aspect of the present disclosure.

FIG. 2A is a schematic view of a dual orthogonal linear array system according to one aspect of the present disclosure.

FIG. 2B is an overhead schematic view of a dual orthogonal linear array system installed on a platform according to one aspect of the present disclosure.

FIG. 3A is a schematic view of a quadrant wing/tail array system according to one aspect of the present disclosure

FIG. 3B is an overhead schematic view of a quadrant wing/tail array system installed on a platform according to one aspect of the present disclosure.

FIG. 4 is a flow chart representing a method of use according to one aspect of the present disclosure.

FIG. 5A is an operational overhead schematic view of a single linear array system installed on a platform according to one aspect of the present disclosure.

FIG. 5B is an operational overhead schematic view of a dual orthogonal linear array system installed on a platform according to one aspect of the present disclosure.

FIG. 5C is an operational overhead schematic view of a quadrant wing/tail array system installed on a platform according to one aspect of the present disclosure.

FIG. 6A is a single scan correlation plot using a prior art single linear array according to one aspect of the present disclosure.

FIG. 6B is a single scan correlation plot using a single linear array of the present system according to one aspect of the present disclosure.

FIG. 7A is a single scan correlation plot using a prior art single linear array system according to one aspect of the present disclosure.

FIG. 7B is a single scan correlation plot using a single linear array of the present system according to one aspect of the present disclosure.

FIG. 8A is a single scan correlation plot using a prior art quadrant wing/tail array system according to one aspect of the present disclosure.

FIG. 8B is a single scan correlation plot using a quadrant wing/tail array of the present system according to one aspect of the present disclosure.

Similar numbers refer to similar parts throughout the drawings.

### DETAILED DESCRIPTION

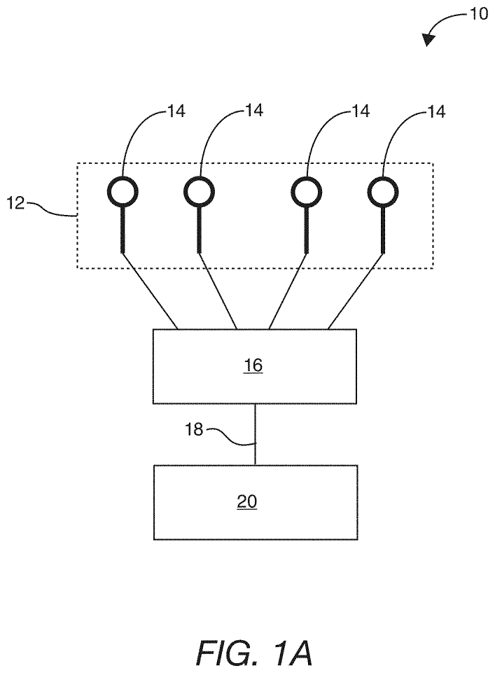

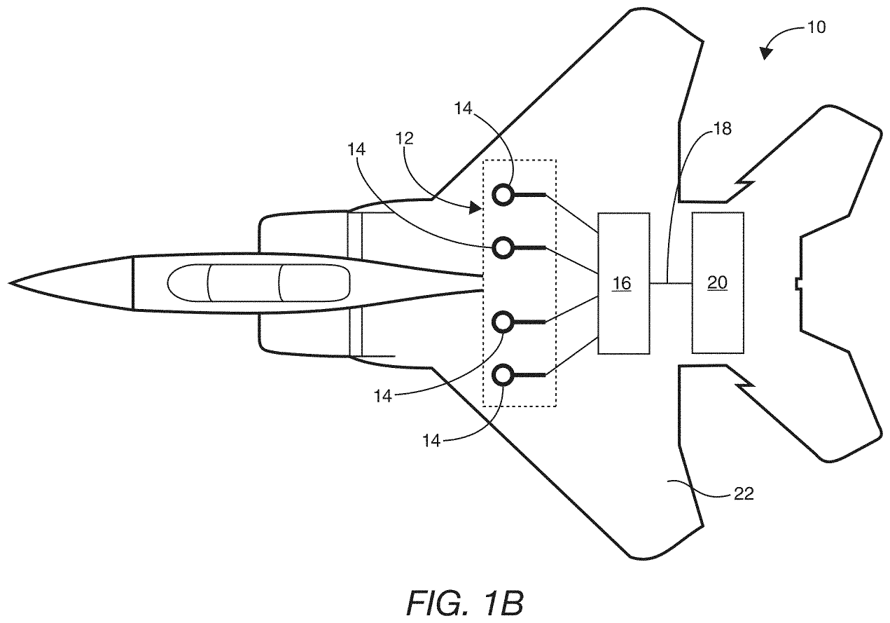

With reference to FIGS. 1A-3B, a direction finding (DF) system is shown and generally indicated at reference 10. DF system 10 may include one or more antenna arrays 12 including one or more antennas 14, a receiver 16, at least one output 18, and a processor 20. As depicted in FIGS. 1B, 2B, and 3B, DF system 10 may be installed on a platform 22 which is depicted and discussed herein as an aircraft; however, DF system 10 may be installed on a variety of platforms 22 as discussed further herein.

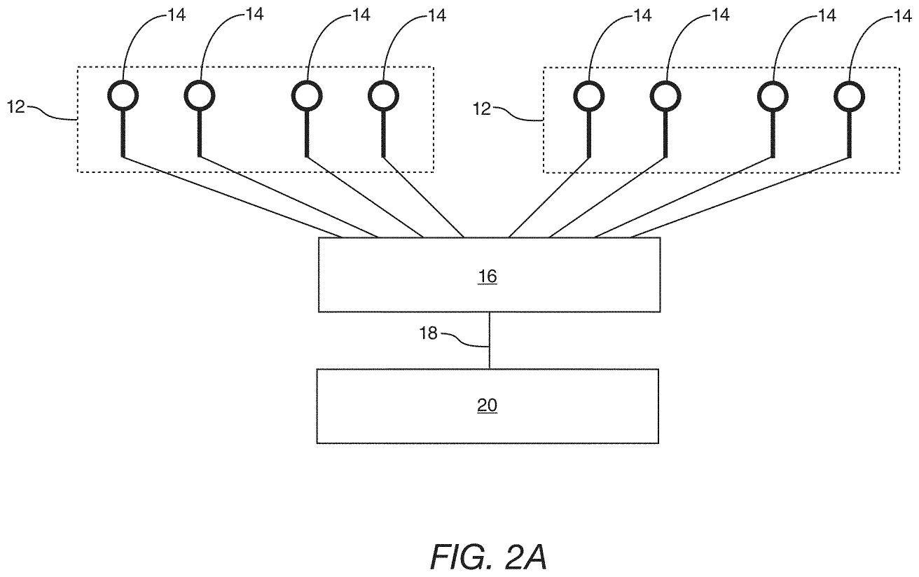

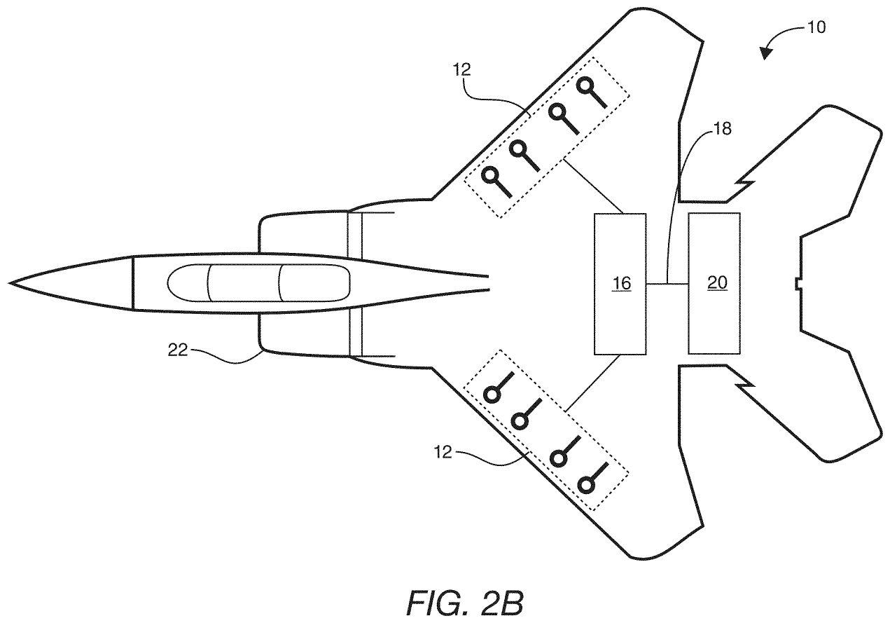

Antenna arrays 12 may include one or more antennas 14 in any configuration and may be installed in any position on platform 22. For example, as depicted in FIGS. 1A and 1B, a single antenna array 12 may be installed on the body of platform 22 and may be arranged with four antennas 14 in a single linear array configuration. Alternatively, as depicted in FIGS. 2A and 2B, two or more antennas 12 may be installed on platform 22, such as on each wing of an aircraft as depicted therein, and each antenna array 12 may have four or more antennas 14 arranged in a dual orthogonal linear array configuration.

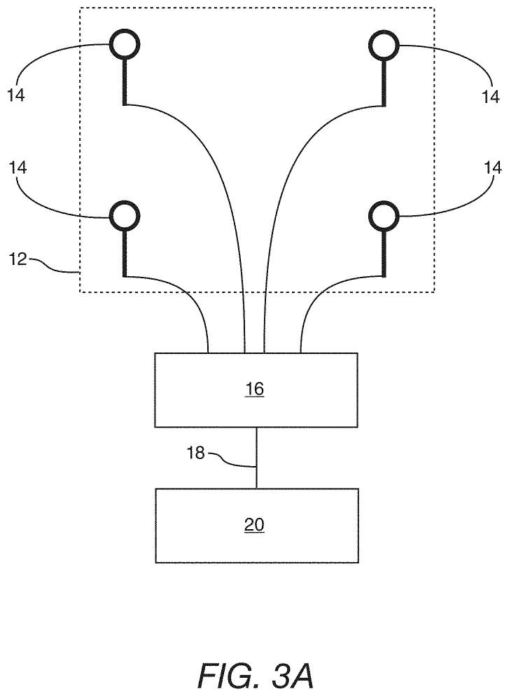

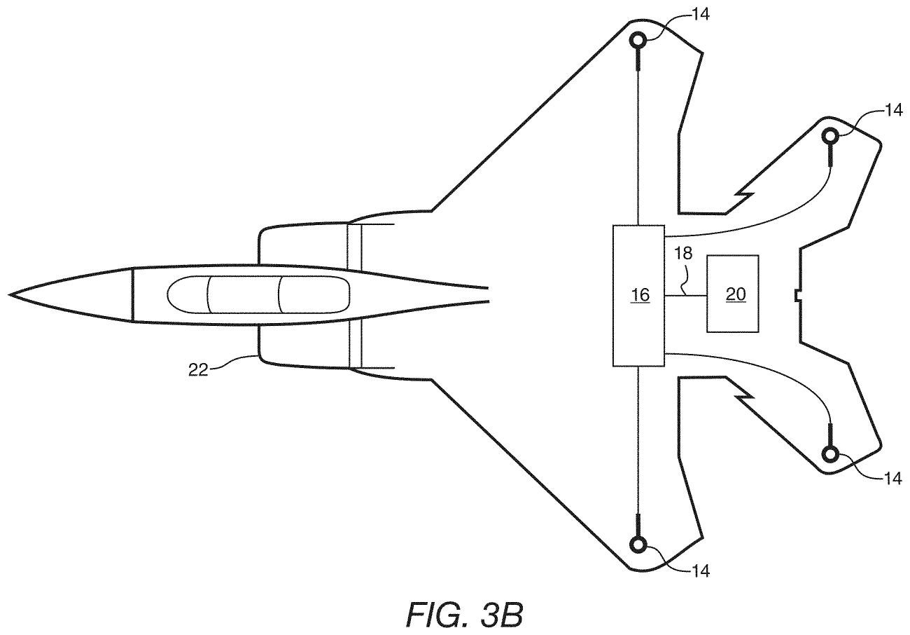

With reference to FIGS. 3A and 3B, antenna array 12 may include four or more antennas 14 that are installed on platform 22 in a quadrant pattern such as depicted in FIG. 3B with one antenna 14 installed on each wing and each side of the tail of an aircraft as shown therein. These various configurations will be discussed further herein with reference to the operation of DF system 10.

Antennas 14 may be monopole, dipole, or directional antennas or any combination thereof and may be arranged in any desired configuration appropriate for their installation conditions. Although discussed predominantly herein in either linear arrangements or quadrant arrangements, antennas 14 may have any desired configuration, including existing legacy configurations, on platform 22 as dictated by the specific installation parameters and the type of platform 22 used. For example, one particular antenna 14 arrangement may work better for a particular platform with another antenna 14 arrangement being better suited for a different platform. By way of one further non-limiting example, an attack aircraft may be better suited for a particular antenna 14 arrangement while a reconnaissance aircraft may find advantages with different or multiple antenna array 12 arrangements.

Receiver 16 may be a computer or processor or alternatively a computing system that can store and/or execute the process or processes disclosed herein. According to one example, the receiver 16 may be a digital receiver that processes digital signals. According to another example, the receiver 16 may be an analog receiver that processes signals in the analog domain wherein such signals are converted to the digital domain for further processing as discussed herein. Alternatively, receiver 16 may be an intermediary between antenna array 12 and processor 20. According to this aspect, receiver 16 can have a direct connection to processor 20 via the at least one output 18.

Output 18 may be a direct wire connection between receiver 16 and processor 20 that can allow unidirectional or bidirectional communications therebetween. According to another aspect, output 18 may be a wireless datalink between receiver 16 and processor 20 utilizing any suitable wireless transmission protocol.

Processor 20 may be a computer, a logic controller, a series of logics or logic controllers, a microprocessor, or the like that can store and/or execute the process or processes disclosed herein. According to one aspect, processor 20 may further include or be in communication with at least one storage medium. According to one aspect, receiver 16, at least one output 18, and processor 20 may be contained within a single unit and, in connection with the at least one storage medium, can store and/or execute the process or processes disclosed herein. According to another aspect, receiver 16 may be remote from processor 20 and in communication therewith.

Receiver 16 and/or processor 20 may further be in communication with other systems on board the platform 22 such that relevant data may be communicated therebetween. For example, where platform 22 is an aircraft, onboard flight systems may relay data to the receiver 16 and/or processor 20 such as heading, altitude, flight speed, geolocation, and the like. Similarly, receiver 16 and/or processor 20 may communicate data regarding detected signals, DF results and the like to the platform 22, including to the operator or operators thereof. As discussed further below, data regarding detected signals, DF results and the like that is communicated to the platform 22 and/or to an operator thereof, may allow responsive actions to be taken by platform. For example, an unmanned aircraft, such as a drone or a guided munition, may take automated actions such as steering towards the signal (as in a targeting situation), steering away from the signal (as in evasive maneuvers), jamming the signal, deploying defensive countermeasures, or any other appropriate responsive action. A manned aircraft make take similar responsive action through automatic response systems (such as deploying countermeasures) or may allow the operator/pilot of the aircraft to choose whether or not to employ any appropriate responsive actions.

Platform 22 may be a vehicle of any type that is capable of moving at sufficient speed to differentiate thee detected signal data across synthetic apertures, as discussed further herein. According to one aspect, as discussed and depicted herein, platform 22 may be an aircraft, either manned or unmanned, including fixed wing and/or rotary aircraft. According to another aspect, platform 22 may be a munition, rocket, or other propelled vehicle. Platform 22 may further be a sea-based or land-based vehicle, provided it may move at a sufficient rate of speed, as discussed further herein.

DF system 10 may include legacy assets, such as legacy antenna arrays 12, antennas 14, receiver 16, outputs 18, and/or processors 20. Any or all of these assets may be legacy assets which may be retrofitted with software or other instructions to accomplish the features of the present disclosure without significantly increasing size, weight, power, or cost to existing legacy DF systems. The process or processes discussed herein may further be uploaded to existing legacy assets or may be added thereto through the use of an additional memory module, including an additional non-transitory storage medium or through the use of temporary memory devices, such as flash memory or the like. Accordingly, the DF system 10 of the present disclosure may allow existing legacy assets to be used without adjustments thereto.

Having thus described the general configuration and components of DF system 10, the operation and method of use thereof will now be discussed.

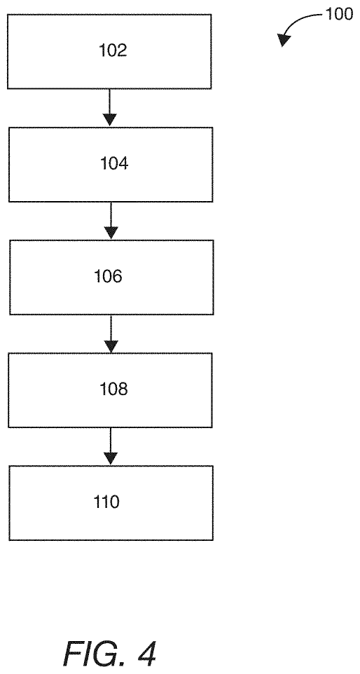

With reference to FIG. 4, the process is shown as a flowchart and indicated generally as process 100. Process 100 may include the detection of an emitted pulse from an emitter having an unknown direction of origin. This detection step is indicated as reference 102. Once detected by the antenna array 12, the signal may be captured by the antenna array 12 and provided to receiver 16. The capturing and communication of the signal to receiver is indicated in process 100 as step 104. At its most basic operational level, receiver 16 may then generate a pulse descriptor word (PDW) as step 106 according to known processes. This PDW may then be delivered through output 18 to processor 20 for further processing. The processing step is indicated as reference 108 in process 100. Finally, once the signal data is processed, a geolocation and DF result may be generated indicating the direction of origin of the signal relative to platform 22, and the geolocation and DF result may be communicated to an operator of the platform 22. The generation and communication of the geolocation and DF result is indicated as reference 110. At its most basic, process 100 will be recognized as a method of use for DF system 10. Each individual step therein will now be further discussed in detail.

As discussed above, platform 22 may be an aircraft carrying DF system 10 thereon and may be operating in an area of operations with known emitter activity. As it relates to process 100 discussed further herein, the example of platform 22 being an aircraft either manned or unmanned will be maintained for simplicity of disclosure, however, it will be understood that platform 22 may be any mobile installation capable of sufficient speeds to accomplish the tasks discussed herein. Further, it will be understood that the operation of platform 22 may be accomplished using the same or similar actions and systems regardless of the configurations of DF system 10 carried thereon. More specifically, three examples have been provided and shown in the figures, particularly FIGS. 1A-3B of aircraft having three different configurations of antenna arrays 12. Process 100 and the operation of platform 22 may have the same or similar steps regardless of which of these three examples of other similar implementations are used.

Emitters in an area of operation are known to generate a pulse of electromagnetic energy, such as radar, in an effort to monitor, locate, and/or identify any aircraft or units operating nearby. In order to maintain agility and minimize the risk of being intercepted, these emitters typically emit a short length pulse that can utilize the motion of the operating unit to gather information about that unit. For example, a radar pulse may be generated for a period of time that is sufficiently long enough to gather information about the unit operating nearby. Common information determined from these pulses may include whether the unit is friend or foe, what type of unit it is, e.g. if the unit is an aircraft, what type of aircraft it is, the speed, heading, and/or direction of origin. Further, the emitter may use the pulse data to determine the number of units as well as their formation, spacing, and similar data. The use of short, non-continuous burst may allow an emitter to gather this information without revealing too much information about the emitter itself. Previous DF systems may receive this short pulse and may be able to produce a generalized correlation between the signal data contained in the pulse and the true angle to the emitter; however, depending upon the specific configuration of the previous DF system, a wide margin of error is typically included therein. Therefore, previous systems tend to require multiple pulses measured over an extended period of time to further hone their accuracy and generate a more reliable and accurate DF result.

DF system 10 of the present process 100 differ in that when a pulse is detected 102 by the array 12, the signal data contained in the pulse may be collected and analyzed to provide a more accurate DF result. Specifically, the receiver 16 may measure the pulse and determine the frequency and begin recording the signal data as it is received. When the pulse transmission ends, firmware and/or software within the receiver 16 may be used to package the signal data collected from the pulse into a PDW which may include generalized information about the pulse, such as the frequency, the pulse width, the amplitude, the duration of the pulse, and other similar information. In addition, receiver 16 may collect data directly from the platform 22 relating to the speed and heading of platform 22 at the time the pulse was received, as well as the geolocation of platform 22 at the time the pulse is received. The receiver 16 may also receive additional information from platform 22 relating to the speed, heading, and/or geolocation of platform 22 throughout the duration of the pulse transmission, thus allowing the receiver 16 to further write spacing for samples into the PDW as discussed further herein.

With reference to FIGS. 2A, 2B, 5B, 8A, and 8B, when DF system 10 utilizes two antenna arrays 12, steps 106 and/or 108 may further include measuring the highest amplitude array first and then measuring the second array by collecting intrapulse measurements. The first array to be measured, as determined by the amplitude of the signal as it is detected, can further insure that the ambiguity of the direction finding result is minimized as the higher amplitude array is likely to receive the detected signal first.

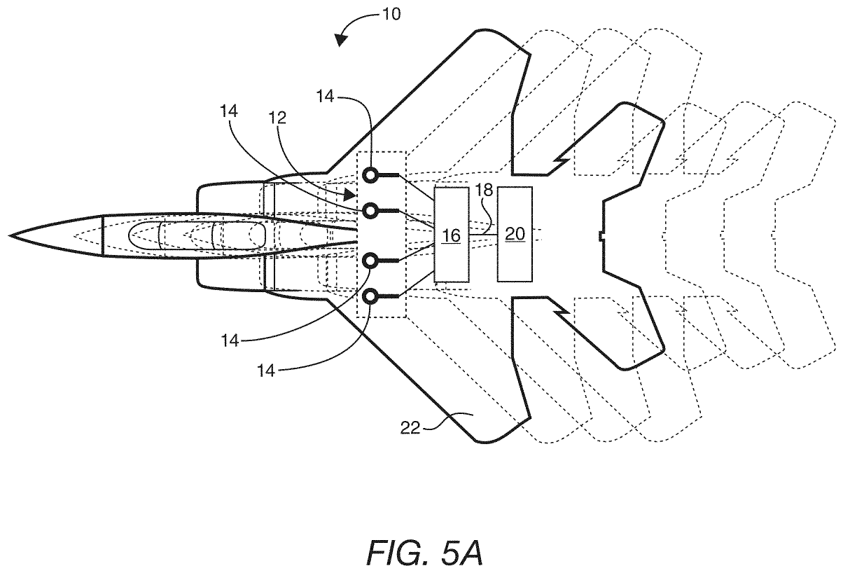

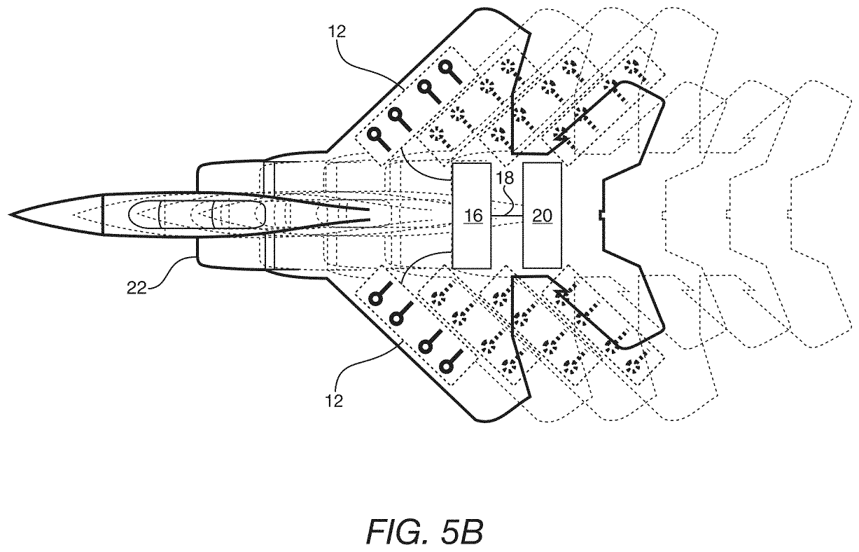

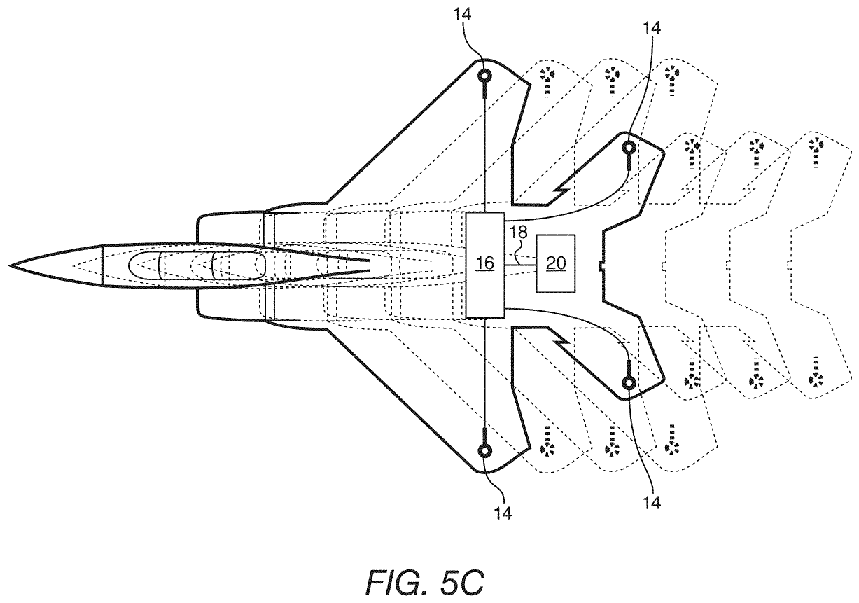

With reference to FIGS. 5A-5C, the present process 100 may exploit the movement of platform 22 to get additional information from the pulse as detected. Specifically, DF system 10 may measure the incident angle of the signal pulse as it comes across antennas 14 in the array 12. Using any number of antennas may allow one to determine the direction from which the signal originated. As the platform moves throughout the duration of the signal pulse transmission, it maintains the measurement of the pulse, however, the antenna phase measurement changes over the duration of the pulse transmission relative to the previous measurements because of this movement of platform 22. Therefore, once the pulse ends, the signal data may be generated into the PDW as a sine wave where it can be determined what portion of the wave or at what phase the wave was detected at the face of each antenna 14 at multiple positions over the duration of the pulse transmission. As seen in FIGS. 5A-5C, the examples shown therein illustrate various array 12 configurations and possible positions on platform 22 with four representative sampling points illustrated therein for each antenna 14 of array 12. Utilizing these as simplified and non-limiting examples, the signal may have a different phase measurement at each antenna 14 at each of the four positions depicted in FIGS. 5A-5C such that the phasor of the signal may be different at each face of each antenna 14 at each of these four positions (prior positions of the antenna array 12 and antennas 14 have been omitted from FIG. 5A for clarity, however, they are to be understood as present, similar to the positions shown in FIGS. 5B and 5C). This may result in four data sets from which to extrapolate a direction finding result as compared to a single data set in prior DF systems.

In actual operation, as platform 22 moves during the duration of the pulse, the sample intervals of the signal may be determined in multiple ways.

According to one embodiment, the sample points may be predetermined regardless of the transmission length (i.e. the period of time the pulse is transmitted/detected, as measured from the start of the pulse until the transmission of the pulse ends) of a detected signal and optimized for signals of varying lengths. For example, a DF system 10 of the present disclosure may include predetermined samplings wherein a signal of unknown duration may be sampled at specific intervals. For example, samples may be taken at each interval of four microseconds for the entire duration of the signal transmission. Thus, a signal with a transmission duration of approximately 24 microseconds will yield approximately six data sets for analyzation while a signal with a transmission duration of approximately 40 microseconds may yield up to 10 data sets for analyzation. Further, according to this embodiment, utilizing predetermined sampling rates may increase the speed at which the DF result may be generated, however, may not result in the highest realizable accuracy from such a system.

According to another embodiment, the sample points may be determined based on the length of the signal and may vary with varying signaling. Specifically, this will result in varying numbers of samples and sample windows dependent upon the length of the signal, as well as the speed and heading of platform 22. By way of a similar non-limiting example, a signal transmission of approximately 24 microseconds in duration may provide that a sampling rate of less than one microsecond may be utilized thereby yielding 24 or more samples. Similarly, a sample rate of half a microsecond may be used thereby providing 48 samples.

Where process 100 is contemplated to use this sampling methodology, it is highly dependent upon the speed of the platform as there needs to be sufficient movement to change the synthetic aperture windows such that each data point represents a different array location for the detected signal. For example, a slow-moving vehicle may not have moved sufficient distance in a half a microsecond to provide a different data set than the previous sample. Thus, a longer sampling window may be used, however, the sampling window should be less than the total length of time of the pulse transmission to provide for multiple samples taken during the duration of the pulse. By way of another non-limiting example, a signal length of 40 microseconds for a slower moving platform 22 may yield fewer sampling windows than a faster moving platform 22 analyzing a 24 microsecond signal transmission.

Regardless of which method is used for determining the sampling windows, it will be understood that these windows may vary depending on a number of factors, including the frequency and/or other characteristics of the signal, as well as factors such as the speed, array placement, and/or setup the array(s) 12 that may be carried by platform 22. Regardless of the method, these sampling windows may then be included in the PDW that is generated in step 106 and sent to processor 20 via output 18 for further processing.

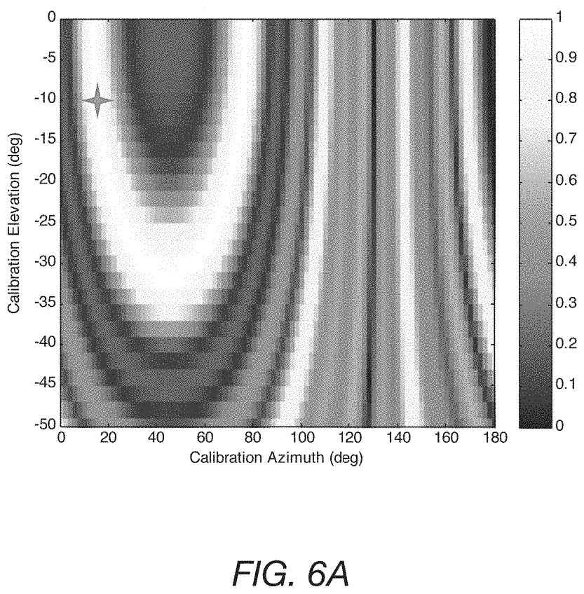

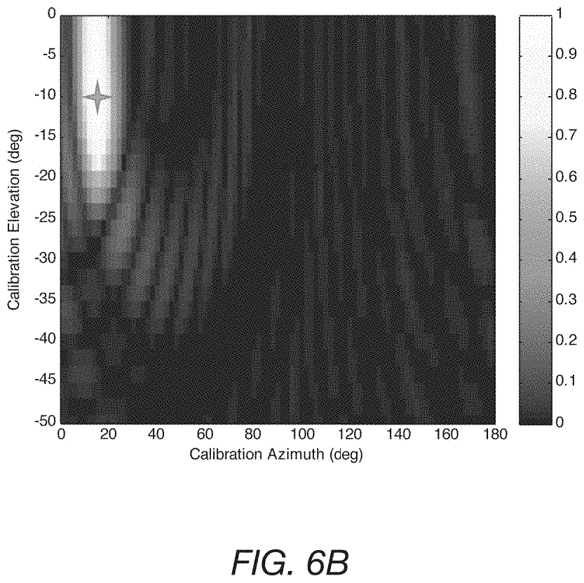

The processing 108 then performed by processor 20 may include a set of instructions stored on a non-transitory storage medium in communication therewith to perform one or more DF processes on the PDW communicated from receiver 16. The DF process or processes may be known processes and may utilize or include correlative interferometry direction finding (CIDF) or other known DF algorithms or processes. The processor 20 may further analyze the PDW to generate geolocations, including correlation graphs, such as those illustrated in FIGS. 6A-8B as discussed below. Then, utilizing the geolocations generated by processor 18 as well as the signal data contained in the PDW, processor 20 may generate (during step 110) a DF result which may be a highly accurate indication of the direction of origin for the detected signal.

The geolocation and DF results may then be communicated (during step 110) to the platform 22 or to an operator of the platform 22 to allow responsive action thereto. Some non-limiting examples of responsive actions have been discussed herein, and may include directing the platform towards or away from the emitter, jamming the emitter, deploying countermeasures, directing munitions, or the like. These responsive actions may be automated or directed by the operator of the platform 22 as appropriate for the specific implementation and objective. Additionally, no response may be chosen, either automatically or by the operator, when appropriate.

It will be understood that additional processing not relevant or not included in process 100 as described herein may be further performed or analyzed to further provide additional information regarding the emitter generating the signal. For example, the specific frequency band utilized by the emitter may give an indication as to what type of emitter has been detected, including whether the emitter is civilian or military. Further, the signal characteristics may be compared to databases created through previous intelligence and/or operations to further classify or otherwise identify the emitter. These data may be highly relevant to the operations of platform 22 in a general sense, but may not have any relevance to process 100 as discussed herein. Therefore, for purposes of this disclosure alone, these additional processing and analyzation steps are not discussed further herein.

With reference to FIGS. 6A and 6B, single scan correlation plots utilizing a single linear array as depicted in FIGS. 1A and 1B are shown. The correlation pattern shown in FIG. 6A represents a correlation plot of a single pulse detected by a single linear array as performed by a prior art direction finding system wherein the single pulse is measured one time. As seen in the key in FIGS. 6A-8B, the greyscale used in the correlation plots shown therein represents the correlation between the detected signal data and the expected signal data from a signal originating from any particular azimuth angle and/or elevation. The correlation is measured on a scale of 0 to 1, with 1 being a perfect correlation and 0 being no correlation at all. As used in FIGS. 6A-8B, the closer to a correlation of 1, the lighter the shading will appear, with pure white representing a perfect or near perfect correlation, and pure black representing no correlation. Thus, the darker any given point is on these correlation plots, the less likely it is that the signal originated from that point. Similarly, the lighter an area appears, the higher the probability that the signal originated from that position.

The star in FIGS. 6A and 6B represents the true angle to the emitter as tested which indicates the emitter was located at 15° azimuth and −10° elevation. As used herein, elevations are represented as negative numbers indicating a direction downwards towards the horizon from the nose of an aircraft serving as platform 22.

As can be seen in FIG. 6A, a single measurement of a single pulse yields a correlation pattern with direction finding results giving an equally likely answer over the U-shaped swathe expanding from approximately 10° azimuth to 70° azimuth and from 0° to approximately −32° elevation. As can be seen, additional high probability results exist in the lighter bands appearing further away from the true angle to the emitter. With reference now to FIG. 6B, a single scan correlation plot with the same true angle emitter, i.e., 15° azimuth and −10° elevation, a single pulse sampled 25 times over one millisecond gives a highly accurate and unambiguous direction finding result probability with a much smaller potential error provided therein. Specifically, when comparing FIG. 6a to FIG. 6B, it is clear that the number of light colored bands is reduced, and many of these light colored bands that originally appeared further away from the true angle to the emitter are eliminated. The remaining light colored areas (i.e. higher probability of origin) are smaller and closer to the true angle to the emitter, thereby increasing the probability of finding the true angle of to the emitter, and reducing the margin of error.

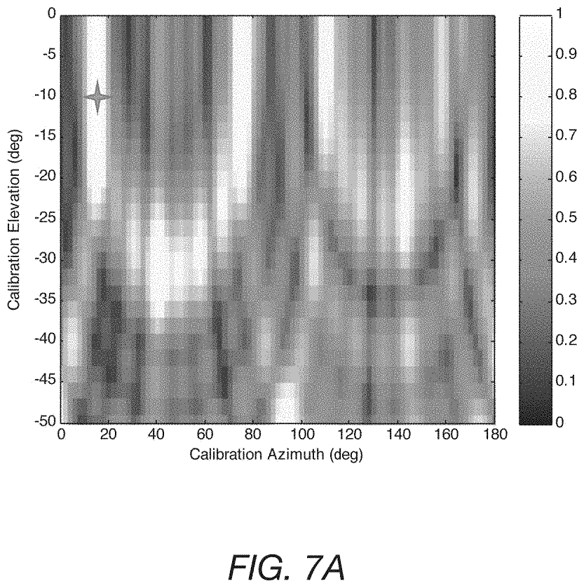

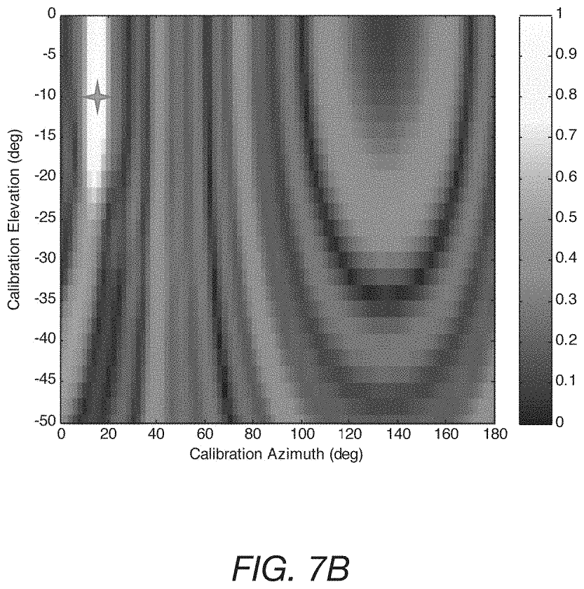

With reference now to FIGS. 7A and 7B, single scan correlation plots are shown utilizing dual orthogonal linear arrays as depicted in FIGS. 2A and 2B. FIGS. 2A again represents a prior art direction finding system wherein a single pulse is measured a single time. As with FIGS. 6A and 6B, the star in FIGS. 7A and 7B represent the true angle to the emitter utilizing an emitter position of 15° azimuth and −10° elevation. As can be seen FIGS. 7A and 7B, the accuracy of the scan and direction finding result is higher than it was with a single linear array, however, the ambiguity potential for the single sample is much higher in FIG. 7A than is shown in FIG. 7B. Therefore, the present DF system 10 as used according to process 100 sampling a single pulse multiple times over the signal transmission length greatly reduces ambiguity and increases the overall accuracy of the DF result.

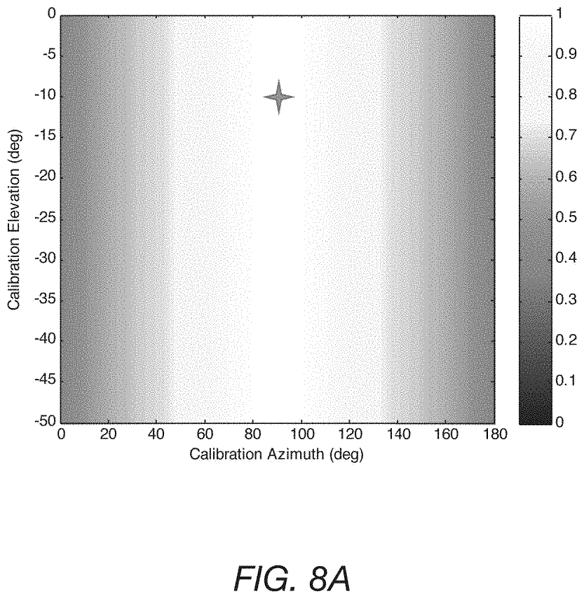

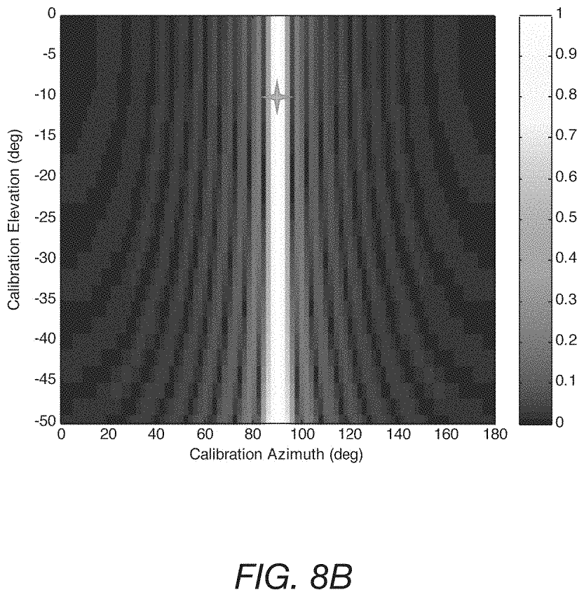

With reference to FIGS. 8A and 8B, correlation plots are again shown, but with a quadrant wing and tail array as depicted in FIGS. 3A and 3B. As with FIGS. 6A-7B, the star in the graph represents the true angle to the emitter. In this instance for FIGS. 8A and 8B, the true emitter location used was at 90° azimuth and −10° elevation. It is of note that quadrant arrays, such as the quadrant wing and tail array 12 used here, are limited to using an amplitude only approach to direction finding as the arrangement of antennas 14 does not provide usable phase data from the detected signal. Therefore, with reference to FIG. 8A, it can be seen that an amplitude only approach provided by a quadrant array may only provide a direction finding result around the azimuth while not allowing discrimination within the signal as to the elevation of the emitter relative to the platform 22. In this instance, as shown in FIG. 8A, the correlation plot utilizing a prior art direction finding system indicates that the emitter is likely to be located between approximately 70° and approximately 110° azimuth and is equally likely at all elevations from 0° to −50° elevation (elevation was limited to this range for the examples provided herein, however, an amplitude only approach would give results that are equally likely over any range of elevation). With reference to FIG. 8B, taking 25 intrapulse measurements over one millisecond according to this example of process 100, can reduce the potential direction finding results giving a much narrower directional band with respect to azimuth and significantly decreasing the ambiguity outside of that band. As depicted in FIG. 8B, the present DF system 10 as used according to process 100 may yield a result of approximately 88° to approximately 92° azimuth with extremely low probabilities of ambiguities outside of that narrow band. Thus, the accuracy of the DF result provided by a quadrant array arrangement may be significantly increased by process 100 as well.

As discussed above, DF system 10 and process 100 may be utilized using legacy systems and adapted for use with any array configuration carried by a platform 22. It is to be further understood that the DF results provided by DF system 10 utilizing process 100 are increased in accuracy and have a lower ambiguity potential for wild bearings, i.e., false results, without increasing the number of antenna elements or arrays needed to be installed and carried by platform 22. Additionally, the present DF system 10 and process 100 may allow more accurate DF results from a single received pulse. Additionally, arrays 12 may be installed and oriented in any direction. However, the present DF system 10 and process 100 may allow a more accurate result than would normally be achieved with a particular array orientation and position. For example, a single linear array may be located on the leading edge of a wing of an aircraft and pointed towards the horizon. However utilizing DF system 10 and process 100 may allow this single linear array to have a high gain as compared to downward pointed array and yet have the DF accuracy of a two-dimensional planar array.

Some sources of error in process 100 may include the heading, velocity, position, geolocation, roll and/or pitch of platform 22, particularly when platform 22 is an aircraft. Additionally, the time measurement accuracy and intrapulse phase measurement accuracy may come into play. Accordingly, as discussed above, receiver 16 and/or processor 20 may be in communication with other systems carried by platform 22 to provide information regarding these particular elements that they may be accounted for in calculating the final DF result utilizing DF algorithms and/or processes as well as accounting for some of these error sources in the creation of the PDW.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A system comprising:
a moving platform;
at least one antenna array including a plurality of antennas therein;
a receiver;
at least one processor capable of executing logical functions in communication with the receiver and the at least one antenna array; and
at least one non-transitory computer readable storage medium having instructions encoded thereon that, when executed by the processor, implements operations to determine the direction of origin for an incoming signal, the instructions including:
detect an incoming signal;
measure a transmission length of the incoming signal;
assign a plurality of sampling apertures for signal data from the incoming signal according to one of more of a velocity, heading, and position of the moving platform;
sample the signal data at more than one of the plurality of assigned sampling apertures;
package the signal data in multiple data sets according to the number of samples taken from the plurality of assigned sampling apertures into a pulse descriptor word (PDW);
apply at least one direction finding process to the PDW; and
generate a geolocation and direction finding result from the PDW.

2. The system of claim 1 wherein the instructions further include:
communicate at least one of the geolocation and direction finding results to one or both of the moving platform and an operator thereof.

3. The system of claim 1 wherein the plurality of sampling apertures are predetermined prior to detection of the incoming signal.

4. The system of claim 1 wherein the plurality of sampling apertures are calculated by the receiver after the incoming signal terminates and further according to the measured length of the incoming signal.

5. The system of claim 1 wherein the moving platform is an aircraft.

6. The system of claim 1 wherein the at least one antenna array is a single linear array.

7. The system of claim 1 wherein the at least one antenna array is a dual orthogonal linear array.

8. The system of claim 1 wherein the signal data is sampled at each of the plurality of assigned sampling apertures.

9. A method of direction finding comprising:
detecting an incoming signal via an antenna array including a plurality of antennas carried by a moving platform;
measuring a transmission length of the incoming signal;
assigning a plurality of sampling apertures for data from the incoming signal according to one or more of the velocity, heading, and position of the moving platform;
sampling the signal data at more than one of the plurality of assigned sampling apertures;
packaging the signal data in multiple data sets according to the number of samples taken from the plurality of assigned sampling apertures into a pulse descriptor word (PDW);
applying at least one direction finding process to the PDW; and
generating a geolocation and direction finding result from the PDW.

10. The method of claim 9 further comprising:
communicating at least one of the geolocation and direction finding results to one or both of the moving platform and an operator thereof.

11. The method of claim 9 further comprising:
predetermining the plurality of sampling apertures prior to detection of the incoming signal.

12. The method of claim 9 wherein the plurality of sampling apertures are calculated by the receiver after the incoming signal terminates and further according to the measured length of the incoming signal.

13. The method of claim 9 wherein the moving platform is an aircraft and the method further comprises:
moving the aircraft from a first position to a second position while detecting the incoming signal.

14. The method of claim 9 wherein the at least one antenna array is a single linear array and detecting the incoming signal is performed by the single linear array.

15. The method of claim 9 wherein the at least one antenna array is a dual orthogonal linear array and detecting the incoming signal is performed by the dual orthogonal linear array.

16. The method of claim 9 further comprising:
sampling the signal data at each of the plurality of assigned sampling apertures.

17. A method comprising:
calculating a plurality of sampling apertures to apply to a signal detected by at least one antenna array with a plurality of antennas carried by a moving platform;
sampling the detected signal at two or more of the plurality of sampling apertures to collect data regarding the signal characteristics;
comparing the collected signal data from each of the two or more sampled apertures and applying at least one direction finding process to the collected signal data; and
communicating the direction finding result to one or both of the moving platform and an operator thereof.

18. The method of claim 17 further comprising:
calculating the plurality of sampling apertures after the detection of the incoming signal and according to the measured transmission length of time of the detected signal and one or more of the velocity, heading, and position of the moving platform.

19. The method of claim 17 wherein the at least one antenna array is a single linear array and detecting the incoming signal is performed by the single linear array.

20. The method of claim 17 wherein the at least one antenna array is a dual orthogonal linear array and detecting the incoming signal is performed by the dual orthogonal linear array.
